(19) United States
(12) Patent Application Publication
(10) Pub. No.: US 2023/0362385 A1
(43) Pub. Date: Nov. 9, 2023

(54) METHOD AND DEVICE FOR VIDEO DATA DECODING AND ENCODING

(71) Applicant: GUANGDONG OPPO MOBILE TELECOMMUNICATIONS CORP., LTD., Dongguan (CN)

(72) Inventors: Marek DOMANSKI, Poznan (PL); Tomasz GRAJEK, Poznan (PL); Slawomir MACKOWIAK, Poznan (PL); Slawomir ROZEK, Poznan (PL); Olgierd STANKIEWICZ, Poznan (PL); Jakub STANKOWSKI, Poznan (PL)

(21) Appl. No.: 18/217,753

(22) Filed: Jul. 3, 2023

Related U.S. Application Data
(63) Continuation of application No. PCT/CN2021/074426, filed on Jan. 29, 2021.

(30) Foreign Application Priority Data
Jan. 4, 2021 (EP) 21461504.9

(51) Int. Cl. H04N 19/136; H04N 19/172; H04N 19/127

(52) U.S. Cl. CPC H04N 19/136; H04N 19/172; H04N 19/127

(57) ABSTRACT

Methods and devices for video data decoding and encoding are provided. The method for video data decoding includes: obtaining a picture bitstream; obtaining a feature bitstream indicating a residual set of features as a result of subtracting a second set of features detected in encoded picture data generated from original picture data by encoding from a first set of features detected in the original picture data; retrieving a decoded set of features from decoding the picture bitstream; and recovering the first set of features indicating the features detected in the input picture data from the decoded set of features and the residual set of features decoded from the feature bitstream.

### CROSS-REFERENCE TO RELATED APPLICATIONS

This is a continuation of International Patent Application No. PCT/CN2021/074426, filed on Jan. 29, 2021, which claims the benefit of priority to European Patent Application No. 21461504.9, filed on Jan. 4, 2021, both of which are hereby incorporated by reference in their entireties.

### BACKGROUND

Video compression is the challenging technology that, in particular, is dramatically important for wireless transmission. Classic video and image compression has been developed independently from encoding of features of images and video. Such an approach seems to be inefficient for the contemporary applications that need high-level video analysis at various locations of the video-based systems like connected vehicles, advanced logistics, smart city, intelligent video surveillance, autonomous vehicles including cars, UAVs, unmanned trucks and tractors, and numerous other applications related to IoT (Internet of Things) as well as augmented and virtual reality systems. Most such systems use transmission links that have limited capacity, in particular, wireless links that exhibit limited throughput, because of physical, technical and economical limitations. Therefore, the compression technology is crucial for these applications.

In the abovementioned applications, video or image is consumed often not by a human being but by machines of very different types: navigation systems, automatic recognition and classification systems, sorting systems, accident prevention systems, security systems, surveillance systems, access control systems, traffic control systems, fire and explosion prevention systems, and very many others. In such applications, the compression technology shall be designed by such means that automatic video analysis will be not hindered when using the decompressed image or video.

The classic image/video compression paradigm is to reduce the numbers of bits whereas preserving relatively good quality of decoded image/video perceived by humans. In the abovementioned applications, the requirement for good image/video quality perceived by humans is not the only requirement for video/image quality. Similarly important or even more important is the efficiency and accuracy of high-level video analysis based on decompressed image or video. As mentioned at the beginning, the practical forthcoming applications will need simultaneous encoding and decoding of image/video and visual features, i.e. features extracted from visual information. The disclosure is related to that task.

### SUMMARY

The present disclosure relates to the technical field of picture and/or video processing and more particular to coding, decoding or encoding of pictures, images, image streams, and videos. More specifically, the present disclosure relates joint encoding and decoding of pictures and the features extracted from such pictures. In specific aspects, the present disclosure relates to corresponding methods and devices.

According to one aspect of the present disclosure, there is provided a method for video data decoding comprising the steps of: obtaining a picture bitstream; obtaining a feature bitstream indicating a residual set of features; retrieving a decoded set of features from decoding the picture bitstream; and obtaining a recovered set of features from the decoded set of features and the residual set of features decoded from the feature bitstream.

According to one aspect of the present disclosure, there is provided a method for video data encoding comprising the steps of: encoding input picture data to obtain encoded picture data as a basis for generating a picture bitstream; performing feature detection on the input picture data to obtain a first set of features; performing feature detection on the encoded picture data to obtain a second set of features; and combining the first set of features and the second set of features for obtaining feature enhancement data.

According to one aspect of the present disclosure, there is provided a video data decoding device, comprising processing resources and an access to a memory resource to obtain code that instructs said processing resources during operation to: obtain a picture bitstream; obtain a feature bitstream indicating a residual set of features; retrieve a decoded set of features from decoding the picture bitstream; and to obtain a recovered set of features from the decoded set of features and the residual set of features decoded from the feature bitstream.

According to one aspect of the present disclosure, there is provided a video data encoding device, comprising processing resources and an access to a memory resource to obtain code that instructs said processing resources during operation to: encode input picture data to obtain encoded picture data as a basis for generating a picture bitstream; perform feature detection on the input picture data to obtain a first set of features; perform feature detection on the encoded picture data to obtain a second set of features; and to combine the first set of features and the second set of features for obtaining feature enhancement data.

### BRIEF DESCRIPTION OF THE DRAWINGS

Embodiments of the present disclosure, which are presented for better understanding the inventive concepts but which are not to be seen as limiting the disclosure, will now be described with reference to the figures in which:

FIG. 1A shows a schematic view of the general conventional configuration;

FIG. 1B shows a schematic view of a general use case as in the conventional arts as well as an environment for employing embodiments of the present disclosure;

FIGS. 2A and 2B show schematic views of configuration embodiments of the present disclosure;

FIG. 3A shows a schematic view of a general device embodiment for the encoding side according to an embodiment of the present disclosure;

FIG. 3B shows a schematic view of a general device embodiment for the decoding side according to an embodiment of the present disclosure; and

FIGS. 4A and 4B show flowcharts of general method embodiments of the present disclosure.

### DETAILED DESCRIPTION

Coding usually involves encoding and decoding. Encoding is the process of compressing and potentially also changing the format of the content of the picture or the video. Encoding is important as it reduces the bandwidth needed for transmission of the picture or video over wired or wireless networks. Decoding on the other hand is the process of decoding or uncompressing the encoded or compressed picture or video. Since encoding and decoding is applicable on different devices, standards for encoding and decoding called codecs have been developed. A codec is in general an algorithm for encoding and decoding of pictures and videos.

Usually, picture data is encoded on an encoder side to generate bitstreams. These bitstreams are conveyed over data communication to a decoding side where the streams are decoded so as to reconstruct the image data. Thus pictures, images and videos may move through the data communication in the form of bitstreams from the encoder (transmitter side) to the decoder (receiving side), and that any limitations of said data communication may result in losses and/or delays in the bitstreams, which, ultimately may result in a lowered image quality at the decoding and receiving side. Although image data coding and feature detection already provide a great deal of data reduction for communication, the conventional techniques still suffer from various drawbacks.

Therefore, there is a need for an efficient technology for joint coding of image or video and visual features. The decoded image or video and visual features should maintain better quality as compared to independent coding of image or video and visual features by the same total bitrate.

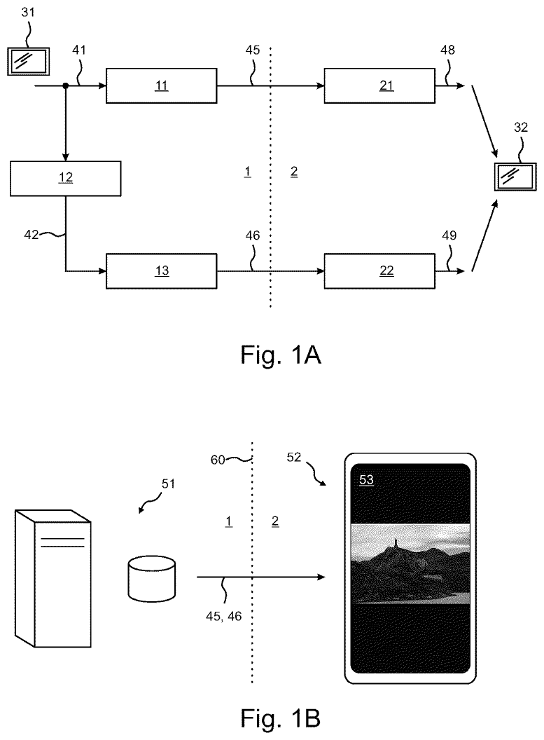

FIG. 1A shows a schematic view of the conventional configuration of separate encoding and decoding of pictures (in the case of the entire present disclosure synonymously understood as video, visual information or a stream of pictures in the form of picture data) and visual features, i.e. features extracted from these pictures or visual information. In general, both the original picture and the extracted features are encoded (compressed) and transmitted in a form of two independent bitstreams to the decoder side. On the decoder side the encoded original picture and the encoded extracted features are decoded in order to obtain reconstructed picture and reconstructed features. Generally, embodiments of the present disclosure may thus consider the extraction of features from a video provided in the form of picture data and encoding residual data of the video in the form of a feature bitstream on the encoding side and extraction of features from a video provided in the form of received picture data and decoding residual data of the video in the form of a received feature bitstream on the decoding side so as to recover and reconstruct original picture data.

More specifically, input picture data 41 (or also named original picture data), forming or being part of a picture 31, a picture stream or a video, is processed at an encoder side 1. The picture data 41 is input to both an encoder 11 as well as to a feature extractor 12, which generates original feature data 42. The latter is also encoded by means of a feature encoder 13, so that two bitstreams, a picture bitstream 45 band a feature bitstream 46 are generated on the encoder side 1. In some embodiments, the two bitstreams are conveyed further separately, whereas in some embodiment the two bitstreams can be multiplexed/mixed into one bitstream, e.g. the feature bitstream can be embedded in the picture bitstream. Generally, the term picture data in the context of the present disclosure shall include all data that contains, indicates and/or can be processed to obtain an image, a picture, a stream of pictures/images, a video, a movie, and the like, wherein, in particular, a stream, video or a movie may contain one or more pictures.

These two bitstreams 45, 46 are conveyed from the encoder side 1 to a decoder side 2 by, for example, any type of suitable data connection, communication infrastructure and applicable protocols. For example, the bitstreams 45, 46 are provided by a server and are conveyed over the Internet and one or more communication network(s) to a mobile device, where the streams are decoded and where corresponding display data is generated so that a user can watch the picture on a display device of that mobile device.

On the decoder side 2, the two streams are received and recovered. A picture stream decoder 21 decodes the picture bitstream 45 so as to generate one or more reconstructed pictures, and a feature decoder 22, decodes the feature bitstream 46 so as to generate one or more reconstructed features. Both the pictures as well as the features form the basis for generating corresponding picture data 32 to be used, processed and displayed at the decoder side's 2 end.

FIG. 1B shows a further schematic view of a general use case as in the conventional arts as well as an environment for employing embodiments of the present disclosure. On the decoding side 1 there is arranged equipment 51, such as data centers, servers, processing devices, data storages and the like that is arranged to store picture data and generate picture and feature bitstreams 45, 46. The bitstreams 45, 46 are conveyed via any suitable network and data communication infrastructure 60 toward the decoding side 2, where, for example, a mobile device 52 receives the bitstreams 45, 46, decodes them and further generates reconstruction data from the picture bitstream and the recovered first set of features indicating recovered picture data. From there it can be generated display data for displaying one or more pictures on a display 53 of the (target) mobile device 52 using appropriate decoding and processing.

As described above, picture data is encoded on an encoder side so as to generate bitstreams. These bitstreams are conveyed over data communication to a decoding side where the streams are decoded so as to reconstruct the picture data. It is this clear that the picture moves through the data communication in the form of bitstreams from the encoder (transmitter side) to the decoder (receiving side), and that any limitations of said data communication may result in losses and/or delays in the bitstreams, which, ultimately may result in a lowered picture quality at the decoding and receiving side. Although picture data coding and feature detection already provide a great deal of data reduction for communication, the conventional techniques still suffer from various drawbacks and the quality of the reconstructed picture data at the receiver may still not be satisfactory.

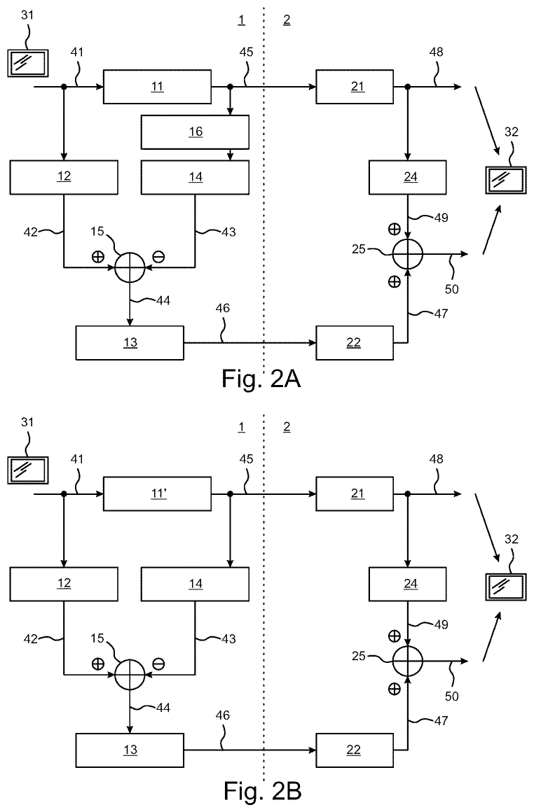

FIG. 2A shows a schematic view of a configuration in which embodiments of the present disclosure can be implemented. In general, there are embodiments of the present disclosure that focus on the encoder side while there are embodiments of the present disclosure that focus on the decoder side. While the embodiments are claimed independently, they may interact in the usual of components similar to the plug-and-socket analogy. According to an embodiment that focuses on the encoding side features are detected from both the original picture data as well as the encoded and then decoded picture data, so that bitstreams can be transmitted from the encoder side 1 to the decoder side 2. On the decoder side 2, the encoded original picture and the encoded extracted features are decoded in order to obtain reconstructed picture and reconstructed features.

More specifically, input picture data 31, forming or being part of a picture, a picture stream or a video, is processed at an encoder side 1. Generally, the term input picture data may refer to original picture data that is subject to encoding and transmission over a network. In a sense, the original picture data may form the base input data as relatively loss-less and high quality picture data. The picture data 31 is input to both an encoder 11 as well as to a feature extractor 12, which generates original feature data 42. According to this embodiment, the encoded picture data 45 is again decoded at a decoder 16 which is preferably located also at the encoder side 1 so as to obtain reconstructed picture data that may comprise features and or characteristics of the compression or encoding rendered previously by means of the encoder 11. As a result, decoded encoded picture data 43 is generated, which is fed to a further feature extractor 14 which generates further feature data 43, which may comprise and/or indicate the features that extracted from the possibly lower quality decoded encoded picture data 43.

Both the feature data 42 as well as the further feature data 43 are fed to a predictor 15, at which the features 42 of a relatively high quality arrive, which have been extracted 12 from the original input image data 41, as well as at which the features 43 of a relatively low quality arrive, which have been extracted 14 from the encoded video/image picture data 45 that will be at least in some form also available at the decoder side. In the predictor 15 there are subtracted the features of a second set of features 43 detected in encoded picture data, which is generated from the input picture data by encoding, from the features of a first set of features 42 detected in the input picture data. In this way, a set of residual features is obtained that forms the basis for generating a feature bitstream 46 indicating a residual set of features as a result of subtracting.

In this way, it can be avoided to transmit in the feature bitstream content (in the sense of general data on the pictures and videos) that can be already attained at the decoder side from the data already available there, since the set of the relatively low quality features can be attained at the decoder side. In this embodiment, there are thus predicted a set of features of a relatively high quality that base on the features of the relatively low quality.

In an embodiment, the corresponding prediction includes the subtraction of the values of the corresponding features as put for example in the following formula,

result_feature=high_quality_feature−low_quality_feature;
which can performed for all corresponding features. In an alternative, the sets of features are predicted so that the set of result features is obtained from subtracting the set of features of relatively low quality from the set of features of relatively high quality as follows:

result_feature_set=high_quality_feature_set−low_quality_feature_set

In general, the mentioned subtraction means that elements in the set of features of a relatively high quality are deleted that already exist in set of features of relatively low quality.

In a further embodiment, the feature data 42 and the further feature data 43 are selectively multiplexed for generating the feature enhancement data 44, wherein only a part of the information on the features in the original picture data as well as on features in the decoded encoded picture data are maintained so as to be available during decoding on the decoding side. For example, a feature that is present in both picture data may be omitted, since the feature is apparently already sufficiently well conveyed to the decoding side via the picture bitstream 45. In such an embodiment, the predictor 15 may act as an adder, wherein the feature data 42 is added (+) and the further feature data 43 is subtracted (−).

In other words, features of a relatively low quality are extracted at the decoder side from the pictures that are coded in the transmitted picture bitstream and enhancement data is added and coded in a transmitted feature bitstream so that features can be reconstructed. As a result, the coded data related to features consists only of limited enhancement data, and not all the features, especially not the features that are conveyed anyway by means of the other picture bitstream. In this way, advantages over existing, state-of-the art alternatives include: 1) decreasing the size of the involved bitstreams since transmitting all image features directly, requires more information to be encoded, and thus to have a bigger bitstream. 2) Maintaining or even improving quality as compared to not transmitting picture features at all and extracting features at the decoder side, which results in only low quality features, as the decoded picture will most likely be deteriorated.

The feature enhancement data 44 is also encoded by means of a feature encoder 13, so that two bitstreams, a picture bitstream 45 and a feature bitstream 46 are generated on the encoder side 1. These two bitstreams 45, 46 are conveyed from the encoder side 1 to a decoder side 2 by, for example, any type of suitable data connection, communication infrastructure and applicable protocols. For example, the bitstreams 45, 46 are provided by a server and are conveyed over the Internet and one or more communication network(s) to a mobile device, where the streams are decoded and where corresponding display data is generated so that a user can watch the picture on a display device of that mobile device.

According to an embodiment that focuses on the decoding side, the picture bitstream 45 and the feature bitstream 46 are obtained on the decoder side 2. The feature bitstream 46 indicates a residual set of features, and a decoded set of features can be obtained from decoding the picture bitstream 45, namely the decoded picture bitstream 48 being obtained by means of the decoder 21. A recovered set of features 50 can be obtained from the decoded set of features 49 and the residual set of features 47 decoded from the feature bitstream 46, namely obtained by decoding the feature bitstream 46 by means of the decoder 22.

In further embodiments, any one of the following options applies: First, the obtained picture bitstream can be generated from input picture data by encoding, potentially at an encoding side. Second, the residual set of features can be obtained as a result of subtracting a set of features detected in encoded picture data generated from input picture data by encoding from a set of features detected in the input picture data. Potentially, said residual set of features can be obtained at an encoding side. Thirdly, said recovered set of features can indicate features detected in input picture data. Fourthly, feature bitstream can be generated from selective prediction, wherein only features are conveyed by said feature bitstream that have not been predicted from encoded picture data. Generally, the term input picture data may refer to original picture data that is subject to encoding and transmission over a network. In a sense, the original picture data may form the base input data as relatively loss-less and high quality picture data.

In other words, the picture bitstream 45 can be generated from input picture data by encoding on an encoder side and can be received, for example, by means of data communication (e.g. Internet, mobile network, etc.). The feature bitstream 46 indicates a residual set of features as a result of subtracting a set of features detected in encoded picture data generated from the input picture data by encoding from a set of features detected in the input picture data. In a way, a condensed differential set of features is conveyed over the feature bitstream 46.

In a picture decoder 21, the picture bitstream 45 is decoded so as to generate a decoded picture bitstream 48 that is further processed in order to generate the picture data 32 to be displayed on the decoding side. The decoded picture data 48 is furthermore fed to a feature extractor 48 so as to practically reproduce the set 43 of the features of relatively low quality in the form of the set 49 of features. In a feature decoder 22, the feature bitstream 46 is decoded so as to obtain the residual set 47 of features. In 25 a set 50 of features is recovered that practically indicates or comprises the features 49 detected in the input picture data from the decoded set of features and the residual set 47 of features decoded from the feature bitstream. In this way, the entire set of features of relatively high quality, as originally available on the encoder side 1 in the form of the set 42 of features, can be reproduced on the decoder side while reducing the amount of data necessary to be communicated for conveying the feature bitstream 46. Generally, the features are detected from both the original picture data as well as the encoded and then decoded picture data, so that bitstreams can be transmitted from the encoder side 1 to the decoder side 2. On the decoder side 2, the encoded original picture and the encoded extracted features are decoded in order to obtain reconstructed picture and reconstructed features.

In other words, on the decoder side 2 the picture features are reconstructed based on prediction of features (relatively low quality features extracted at the decoder 24) and based on kind of a prediction error as transmitted in the feature bitstream 46.

Embodiments of the present disclosure can thus provide one or more advantages, wherein the accuracy of the feature detection is improved by extracting features also from the first encoded and then again decoded video. Such features may be strongly deteriorated when the bitrate during conveying the respective bitstreams is low for video transmission. In this way, the feature fidelity may be improved by the additional stream of encoded enhancement data for features, as exemplified in conjunction with FIG. 2 as the features bitstream 46′. This may—in particular—also more efficient than simulcast compression of the features.

The embodiments of the present disclosure thus consider a coding of features that are extracted from the original picture, which consists in usage of prediction of these features based on features extracted from the reconstructed picture. Generally, the embodiments of the present disclosure consider monochromatic and color pictures/video, still and moving pictures (video), various applicable feature extractions and detection methods including, but not limited to, linear filtering, nonlinear filtering, filtering with particular emphasis on neural-network-based feature extraction methods. Such feature extraction methods can result in discrete features, such as scale-invariant feature transform (SIFT), compact descriptors for video analysis (CDVA), and compact descriptors for visual search (CDVS).

Further, the embodiments of the present disclosure can find their application in any one of the various applicable video codecs, including, but not limited to, like JPEG, JPEG 2000, JPEG XR, PNG, MPEG-2 (H.262), AVC (H.264), AVS (any version), HEVC (H.265), VC-1, HEVC (H.266), AV1, EVC, VVC and others. Further, the embodiments may be independent from the actually employed compression technology, e.g. as employed in any encoder/decoder 11, 11′, 13, 21, 22 applied to both picture and video compression and to encoding and compressing the enhancement data for features.

FIG. 2B shows a schematic view of a further configuration embodiment of the present disclosure. The aspects and elements are the same or similar to those as disclosed and described in conjunction with FIG. 2A, except for that an encoder 11′ is employed which does inherently provide a reconstructed picture, and thus the usage of a decoder, e.g. the decoder 16 of FIG. 2A, on the encoder side 1 is not needed. In this embodiment, the encoded picture data can be directly fed to the further feature extractor 14 for generating the further feature data 43.

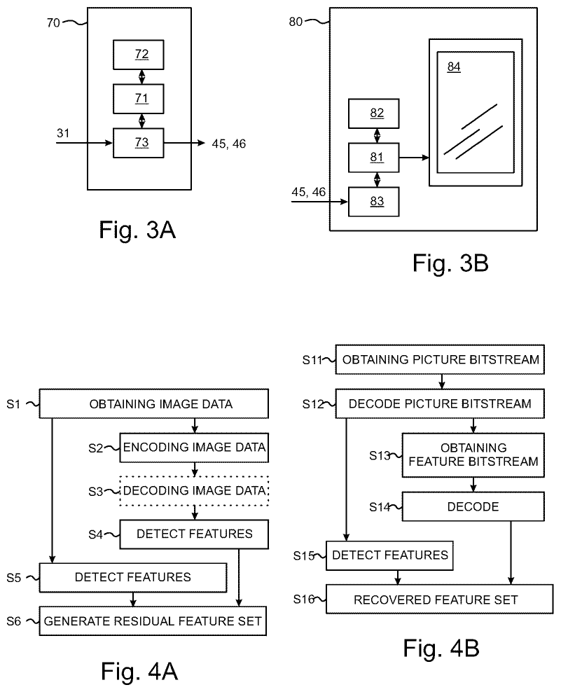

FIG. 3A shows a schematic view of a general device embodiment for the encoding side according to an embodiment of the present disclosure. An encoding device 70 comprises processing resources 71, a memory access 72 as well as an interface 73. The mentioned memory access 72 may store code or may have access to code that instructs the processing resources 71 to perform the one or more steps of any method embodiment of the present disclosure an as described and explained in conjunction with the present disclosure.

Specifically, the code may instruct the processing resources 71 to obtain over the communication interface 73 picture data 31 to be encoded, which is encoded to obtain encoded picture data as a basis for generating a picture bitstream 45, that can be output toward a decoder side via the communication interface 73. Optionally, there may be code that perform decoding of the encoded data. From the encoded or decoded encoded picture data there is performed feature detection to obtain a second set of features. If the encoding has inherently a reconstructed picture, then the decoding may be omitted. The obtained picture data is further subject to feature detection to obtain a first set of features. This set of features, as well as the second set of features are combined of combing the first set of features and the second set of features for obtaining feature enhancement data 46′, which can be output as a further bitstream.

Said processing resources can be embodies by one or more processing units, such as a central processing unit (CPU), or may also be provided by means of distributed and/or shared processing capabilities, such as present in a datacentre or in the form of so-called cloud computing. Similar considerations apply to the memory access which can be embodied by local memory, including but not limited to, hard disk drive(s) (HDD), solid state drive(s) (SSD), random access memory (RAM), FLASH memory. Likewise, also distributed and/or shared memory storage may apply such as datacentre and/or cloud memory storage.

FIG. 3B shows a schematic view of a general device embodiment for the decoding side according to an embodiment of the present disclosure. A decoding device 80 comprises processing resources 81, a memory access 82 as well as an interface 83. The mentioned memory access 82 may store code or may have access to code that instructs the processing resources 81 to perform the one or more steps of any method embodiment of the present disclosure an as described and explained in conjunction with the present disclosure. Further, the device 80 may comprise a display unit 84 that can receive display data from the processing resources 81 so as display content in line with picture data. The device 80 can generally be a computer, a personal computer, a tablet computer, a notebook computer, a smartphone, a mobile phone, a video player, a tv set top box, a receiver, etc. as they are as such known in the arts.

Specifically, the code may instruct the processing resources 81 to obtain over the communication interface 83 picture bitstream 45 and a feature bitstream 46. The latter may indicate a residual set of features as a result of subtracting a set of features detected in encoded picture data generated from the input or original picture data by encoding from a set of features detected in the input or original picture data. The code may instruct the processing resources 81 further to retrieve a decoded set of features from decoding the picture bitstream and to obtain a recovered set of features from the decoded set of features and the residual set of features decoded from the feature bitstream. The code may further instruct the processing resources 81 to generate display data to be displayed on a display unit 84.

FIG. 4A shows a flowchart of a general method embodiment of the present disclosure. Specifically, there is shown a method of video data encoding that comprises an optional step S1 of obtaining input picture data to be encoded. This input picture data is in step S2 encoded to obtain encoded picture data as a basis for generating a picture bitstream. Optionally, this encoded picture data is decoded in step S3 and in a step S4 feature detection is performed on the decoded picture data to obtain a second set of features. If the encoding in step S2 has inherently a reconstructed picture, then the decoding in step S3 may be omitted and the method may directly after step S3 proceed to step S4. The input picture data is further in a step S5 subject to feature detection to obtain a first set of features. This set of features, as well as the second set of features are used in a step S6 of generating a residual set of features as described in greater detail elsewhere in the present disclosure.

FIG. 4B shows a flowchart of a general method embodiment of the present disclosure. Specifically, there is shown a method of video data decoding that comprises a step S11 of obtaining a picture bitstream which may be generated from input/original picture data by encoding and a step S13 of obtaining a feature bitstream. The latter may indicate a residual set of features as a result of subtracting a set of features detected in encoded picture data generated from input or original picture data by encoding from a set of features detected in the that input or original picture data. In a step S14, the feature bitstream may be decoded so as to obtain a residual set of features. The method further comprises a step S12 of decoding the picture bitstream and a step S15 of retrieving a decoded set of features from the decoded picture bitstream. In a step S16, there is obtained a recovered set of features from the decoded set of features and the residual set of features decoded from the feature bitstream.

Specifically, embodiments of the present disclosure may provide substantial benefits regarding the quality and fidelity of the reconstructed picture or video data at a receiving side, while still maintaining or even yet reducing the necessary data throughput by involved data communication for conveying the bitstreams. Further advantages may include also reduced data processing at any one of an encoder/transmitter side and decoding/receiving side.

Although detailed embodiments have been described, these only serve to provide a better understanding of the disclosure defined by the independent claims and are not to be seen as limiting.

1. A method for video data decoding comprising the steps of:
obtaining a picture bitstream;
obtaining a feature bitstream indicating a residual set of features;
retrieving a decoded set of features from decoding the picture bitstream; and
obtaining a recovered set of features from the decoded set of features and the residual set of features decoded from the feature bitstream.

2. The method of claim 1, wherein the recovered set of features is obtained as a sum of the decoded set of features and the residual feature set decoded from the feature bitstream.

3. The method of claim 1, further comprising a step of decompressing and decoding the feature bitstream so as to obtain the residual set of features.

4. The method of claim 1, further comprising a step of generating reconstruction data from the picture bitstream and the recovered set of features.

5. A method for video data encoding comprising the steps of:
encoding input picture data to obtain encoded picture data as a basis for generating a picture bitstream;
performing feature detection on the input picture data to obtain a first set of features;
performing feature detection on the encoded picture data to obtain a second set of features; and
combining the first set of features and the second set of features for obtaining feature enhancement data.

6. The method of claim 5, further comprising a step of decoding the encoded picture data to obtain decoded encoded picture data on which then feature detection is performed to obtain said second set of features.

7. The method of claim 5, further comprising a step of generating a picture bitstream from said encoded picture data.

8. The method of claim 5, further comprising a step of generating a feature bitstream from said feature enhancement data.

9. The method of claim 8, wherein said generating the feature bitstream comprises encoding said feature enhancement data.

10. The method of claim 5, further comprising multiplexing bitstreams so as to convey the picture data in an encoded form toward a decoding side.

11. The method of claim 5, wherein said combining of the first set of features and the second set of features comprises concatenating features of both sets for generating said feature enhancement data.

12. The method of claim 5, wherein said combining of the first set of features and the second set of features comprises selecting features of the sets of features so that only selected features enter for generating said feature enhancement data.

13. The method of claim 5, wherein said combining of the first set of features and the second set of features comprises omitting features that are present in both sets of features.

14. The method of claim 5, wherein said picture data include data that contains, indicates and/or can be processed to obtain an image, a picture, a stream of pictures/images, a video, a movie, and the like, wherein, in particular, a stream, video or a movie may contain one or more pictures.

15. A video data decoding device, comprising processing resources and an access to a memory resource to obtain code that instructs said processing resources during operation to:
obtain a picture bitstream;
obtain a feature bitstream indicating a residual set of features;
retrieve a decoded set of features from decoding the picture bitstream; and to
obtain a recovered set of features from the decoded set of features and the residual set of features decoded from the feature bitstream.

16. The video data decoding device of claim 15, comprising a communication interface configured to receive communication data conveying the picture bitstream and the feature bitstream over a communication network.

17. The video data decoding device of claim 16, wherein the communication interface is adapted to perform communication over a wireless mobile network.

18. The video data decoding device of claim 15, further comprising a display unit configured to display content based on the obtained picture bitstream and feature bitstream.

19. A video data encoding device, comprising processing resources and an access to a memory resource to obtain code that instructs said processing resources during operation to:
encode input picture data to obtain encoded picture data as a basis for generating a picture bitstream;
perform feature detection on the input picture data to obtain a first set of features;
perform feature detection on the encoded picture data to obtain a second set of features; and to
combine the first set of features and the second set of features for obtaining feature enhancement data.
